(19) United States
(12) Patent Application Publication
(10) Pub. No.: US 2006/0089968 A1
(43) Pub. Date: Apr. 27, 2006

(54) Terminal for mobile communications

(75) Inventors: Sung Ho Park, Seoul (KR); Hee Bong Park, Gunpo-si (KR); Jay Woong Yun, Goyang-si (KR); Ju Rag Sohn, Seoul (KR); Seong Rae Kim, Seoul (KR); Un Cheol Lee, Gyeonggi-do (KR); Suk Jin You, Inchon (KR)

Correspondence Address: LEE, HONG, DEGERMAN, KANG & SCHMADEKA;14th Floor, 801 S. Figueroa Street, Los Angeles, CA, 90017, US

(73) Assignee: LG Electronics Inc.

(21) Appl. No.: 11/259,238

(22) Filed: Oct. 25, 2005

(30) Foreign Application Priority Data
Oct. 25, 2004 (KR) 10-2004-0085380

(51) Int. Cl. G06F 15/16

(52) U.S. Cl. 709/203

(57) ABSTRACT

A mobile telecommunications terminal is disclosed, in which an adaptive software development platform corresponding to user interface (UI) or man machine interface (MMI) is effective for the development of application programs and fast changing product specification. The mobile communication terminal having a adaptive software development platform, wherein the platform comprises: an events buffer for storing the signals and events generated by a terminal operating system (OS); an event processor for handling the signals and the events output from the events buffer and for transmitting the signals and events to a corresponding application; and a window manager for providing resources operated by the event processor and controlling the terminal applications operations.

### CROSS-REFERENCE TO RELATED APPLICATIONS

This application claims priority under 35 U.S.C. § 119 for Korean Patent Application No. 10-2004-0085380, filed on Oct. 25, 2004, which is hereby incorporated by reference as if fully set forth herein.

### FIELD OF THE INVENTION

The present invention relates to a terminal for mobile telecommunications, and more particularly, to a terminal for mobile telecommunications in which software corresponding to a user interface (UI) or a man machine interface (MMI) is changed to effectively develop application programs and to adapt to the fast pace of product specification change.

### BACKGROUND OF THE INVENTION

Wireless telecommunication systems had been used only for special purposes until the 1970's. Mobile telecommunication services based on wireless telecommunication technology have been used commercially since the early 1980's. In the 1980's, the use of mobile telecommunication markets has rapidly increased and the age of digital mobile telecommunication arrived in the 1990's. Therefore, the mobile telecommunication service has changed from cellular type mobile communication services based on macro cells to personal communication services (PCS) based on micro cells.

Since 1984 in Korea, mobile telecommunication services have been analog and have made rapid growth. Studies for digital mobile telecommunication services started in the latter half of 1980's. Also, a code division multiple access (CDMA), developed by Qualcomm, had been adopted as the standard for Korean digital mobile telecommunication services. A CDMA system was developed in 1995, and digital cellular mobile telecommunication services based on CDMA started in 1996.

FIG. 1 illustrates a user interface (UI) of a terminal for mobile telecommunications according to the related art. FIG. 1 shows UI related code software comprising a task part 110 having a Handset (HS) task, Main Control (MC) task, Call Manager (CM) task, and a File System (TS) task etc. and has a structure of a state machine 120. The state machine 120 comprises a signal & event handler 121, a system function 124, a state manager 123, a call back unit 122, and an application unit 125. The state manager 123 manages each event handler. Each application of the application unit 125 is entangled with each another in a complicated structure.

In the related art, the existing code is necessarily updated for a new function and is not reused. Also, an update of almost all applications is required when the existing UI specification is changed. When a service provider develops applications, the whole source code should be provided to the service provider because coding is not independent from operational states. In this case, a security risk may occur. Furthermore, when the system is continuously upgraded, the system is likely to incur unexpected errors due to mutual relationship of the operational states. Also, it is difficult to reuse application programs and adapt to new functions. Moreover, much time and difficulty are required to quickly develop software adapted to hardware changes.

### SUMMARY OF THE INVENTION

Accordingly, the present invention is directed to a mobile telecommunications terminal that substantially obviates one or more problems due to limitations and disadvantages of the related art.

An object of the present invention is to provide a mobile telecommunications terminal, which allows an application program to be effectively developed and is adapted to fast changes of product specifications.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile telecommunications terminal having an Adaptive Software Development Platform (ASDP) according to the present invention comprises an events buffer for storing signals and events generated by a terminal operating system (OS), a handler managing the signals and the events output from the events buffer to transmit them to a corresponding application, and a window manager providing resources for the handler and controlling the terminal application operations.

The handler further comprises a system events manager managing signals and events unintended by a user of the terminal and an application events manager managing signals and events intended by the user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating software for a mobile telecommunications terminal according to the related art; and

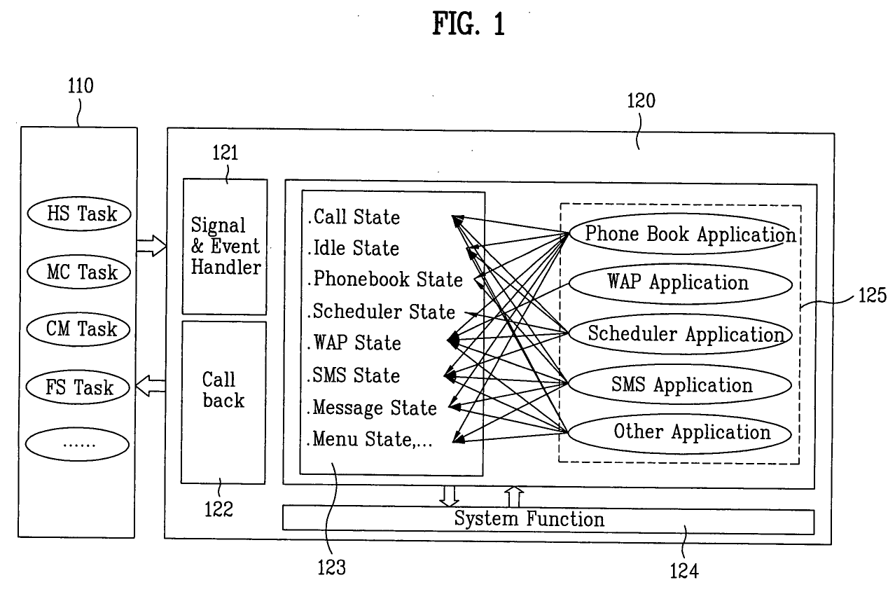

FIG. 2 is a block diagram illustrating a software structure for a mobile telecommunications terminal according to an embodiment of the present invention.

### DETAILED DESCRIPTION OF THE EMBODIMENTS

Reference will now be made in detail to the embodiments of the present invention, examples of which are illustrated in the accompanying drawings. Wherever possible, the same reference numbers will be used throughout the drawings to refer to the same or like parts.

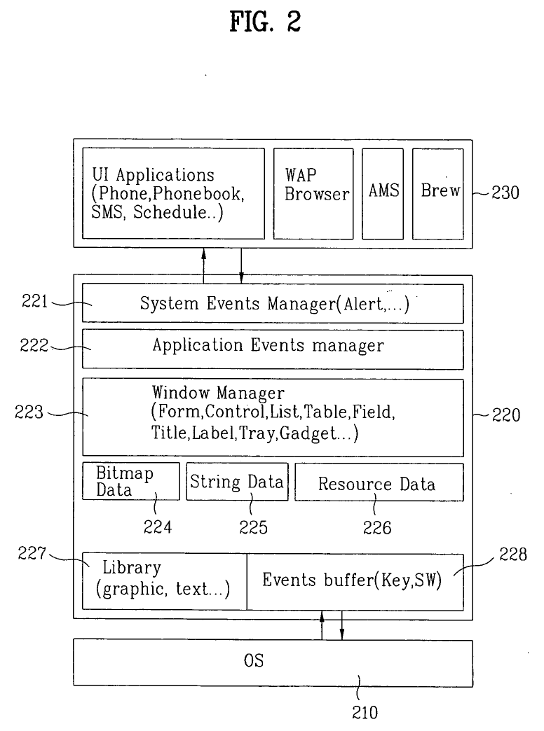

FIG. 2 is a block diagram illustrating a software structure for a mobile telecommunications terminal according to one embodiment of the present invention. In the software structure according to the present invention, a configuration of an improved adaptive software development platform (ASDP) 220 corresponding to a UI or an MMI is shown.

The ASDP 220 connects a terminal operating system (OS) 210 with an application unit 230. The terminal OS 210 operates applications of the application unit 230 in accordance with the interface structure of the ADSP 220.

The ASDP 220 includes a library 227 and an events buffer 228. The library 227 serves to store images or text strings and will display the images or the text strings in the terminal. The events buffer 228 stores either a user's key events or system events, which may be generated in software, or events such as calls, short message service (SMS), and alarms, that may occur.

An event processor and a window manager 223 manage the events being stored by the events buffer 228. The event processor includes a system events manager 221 and an application events manager 222.

The system events manager 221 manages incoming calls and events such as transmission and reception of SMS. The application events manager 222 manages events that are user initiated and not handled by the system events manager 221. That is, the application events manager 222 mainly manages user intended events. For example, the application events manager 222 manages all the events moved from one application to another application or handled by a corresponding application.

The window manager 223 provides object-oriented resources, such as form, control, list, table, and field data required by the application events manager 222. The window manager 223 provides application programming interfaces (APIs) required to display the form, the control, the list, the table, the field, and so on. The steps of managing the events or signals using each manager based on the above conditions are displayed in the terminal. A bitmap tool such as Bitmap Converter provides bitmap data 224. Resource Data 226 is provided by resource tools as like a resource constructor or a resource compiler. String data 225 is provided from the library 227.

All the UI applications, WAP browser, AMS, and Brew of the application unit 230 are operated based on the ASDP 220 structure.

As described above, the mobile telecommunications terminal according to the present invention provides mechanism to quickly adapt to changes of market and technology using an automated development tool. Also, it is possible to stably construct an optimized terminal platform and to continuously develop new products.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile communication terminal having an Adaptive Software Development Platform (ADSP), the platform comprising:
an events buffer for storing signals and events generated by a terminal operating system (OS);
an event processor for receiving the signals and events from the events buffer and for transmitting the signals and events to a corresponding application; and
a window manager for providing resources from the event processor and for controlling terminal applications operations.

2. The terminal of claim 1, wherein the event processor comprises:
a system events manager managing system initiated signals and events; and
an application events manager managing user initiated signals and events.

3. The terminal of claim 1, wherein the resources comprise form, control, list, table, and field application programming interfaces.

4. An Adaptive Software Development Platform (ADSP) comprising:
an events buffer for storing signals and events generated by a terminal operating system (OS);
an event processor for receiving the signals and events from the events buffer and for transmitting the signals and events to a corresponding application; and
a window manager for providing resources from the event processor and for controlling terminal applications operations.

5. The software development platform of claim 4, wherein the event processor comprises:
a system events manager managing system initiated signals and events; and
an application events manager managing user initiated signals and events.

6. The software development platform of claim 4, wherein the resources comprise form, control, list, table, and field application programming interfaces.

7. An Adaptive Software Development Platform (ADSP) comprising:
a means for storing signals and events generated by a terminal operating system (OS);
a means for receiving the signals and events from the means for storing signals and events, and for transmitting the signals and events to a corresponding application; and
a means for providing resources from the means for receiving and transmitting signals and events, and for controlling terminal applications operations.

8. The software development platform of claim 7, wherein the means for receiving and transmitting signals and events comprises:
a means for managing system initiated signals and events; and
a means for managing user initiated signals and events.

9. The software development platform of claim 7, wherein the resources comprise form, control, list, table, and field application programming interfaces.

10. A mobile communication terminal having an Adaptive Software Development Platform (ADSP) comprising:
a means for storing signals and events generated by a terminal operating system (OS);
a means for receiving the signals and events from the means for storing signals and events, and for transmitting the signals and events to a corresponding application; and
a means for providing resources from the means for receiving and transmitting signals and events, and for controlling terminal applications operations.

11. The terminal of claim 10, wherein the means for receiving and transmitting signals and events comprises:
a means for managing system initiated signals and events; and
a means for managing user initiated signals and events.

12. The terminal of claim 10, wherein the resources comprise form, control, list, table, and field application programming interfaces.
